(19) United States
(12) Patent Application Publication
(10) Pub. No.: US 2026/0152165 A1
(43) Pub. Date: Jun. 4, 2026

(54) NOISE REDUCTION SYSTEMS FOR QUICK RELEASE VALVES

(71) Applicant: Kenneth R. Andersen, II, Arlington, VA (US)

(72) Inventor: Kenneth R. Andersen, II, Arlington, VA (US)

(21) Appl. No.: 19/409,622

(22) Filed: Dec. 4, 2025

Related U.S. Application Data
(60) Provisional application No. 63/703,671, filed on Oct. 4, 2024.

(51) Int. Cl. B60T 17/00; B33Y 80/00

(52) U.S. Cl. CPC B60T 17/008; B33Y 80/00

(57) ABSTRACT

A noise-reduction system for pneumatic quick release valves includes a module attachable to an exhaust outlet of an existing valve or integrated directly into a valve housing. Noise reduction may be achieved using either a single asymmetric discharge outlet or multiple outlets, depending on implementation. In various embodiments, noise reduction is achieved using expansion chambers, turbulence-generating features, or exhaust-port geometries—including single or multiple non-circular outlets—configured to disrupt coherent airflow and reduce tonal and broadband noise. Optional features include resonator cavities, micro-structured liners, perforated elements, porous or composite media, and additive-manufactured structures. The system may be implemented as a retrofit module or as part of an original-equipment valve assembly and may include sensors or diagnostic features for performance monitoring. The disclosed designs maintain required brake-system performance and durability for heavy-duty vehicle environments.

### FIELD OF THE DISCLOSURE

The present disclosure relates to pneumatic brake systems for heavy-duty vehicles. More particularly, the disclosure relates to quick release valves (QRVs) and noise-reduction structures integrated into or attachable to such valves to reduce tonal and broadband acoustic emissions produced during brake exhaust events.

### BACKGROUND

Heavy-duty commercial vehicles, including buses, trucks, and construction equipment, rely on high-pressure pneumatic brake systems typically operating at pressures between approximately 100 and 150 pounds per square inch. During brake release, quick release valves (QRVs) exhaust pressurized air to the atmosphere in a rapid discharge event designed to ensure fast brake response.

Conventional QRVs generally employ a single circular exhaust outlet. Circular exhaust ports tend to accelerate discharged air to high velocities and promote coherent jet formation. The symmetry and boundary conditions inherent to circular openings facilitate vortex shedding, shear-layer instabilities, standing-wave formation, and Helmholtz-type resonance behaviors. These aeroacoustic mechanisms are known to generate tonal whistling in a variety of geometric apertures, ducts, and orifice-based systems.

The tonal signature produced by such QRVs frequently manifests as a sharp, high-frequency whistle or squeal that is objectionable in urban corridors, transit terminals, enclosed bus depots, residential streets, and pedestrian-dense environments. Sound levels may be sufficiently high to cause discomfort to bystanders and operators, contributing to overall noise pollution.

Various external mufflers and add-on accessories have been proposed for brake-exhaust noise reduction. However, many such devices rely primarily on simple downstream attenuation rather than addressing the internal flow-acoustic mechanisms within the exhaust pathway itself. Certain prior external devices may be susceptible to degradation from moisture, road debris, or temperature cycling, and some configurations may be removable or bypassable during maintenance. Moreover, conventional downstream-only silencers typically lack features such as internal expansion geometry, turbulence-generating structures, resonators, or micro-structured surfaces that mitigate coherent jet formation and flow-acoustic feedback. The foregoing discussion is provided for background only and is not an admission that any referenced devices or approaches constitute prior art.

There remains a need for integrated, robust, and optionally retrofit-capable noise-reduction systems that suppress tonal and broadband acoustic emissions at their source while maintaining required pneumatic performance, durability, and compatibility with existing brake-system architectures.

### SUMMARY

The present disclosure provides systems, modules, and integrated QRV housings incorporating one or more features configured to reduce tonal and broadband acoustic emissions produced during brake release. In various embodiments, these features may include expansion chambers, turbulence-generating structures, micro-structured liners, additive-manufactured geometries, resonator cavities, or one or more exhaust-port geometries—including single-outlet or multi-outlet configurations—selected to disrupt coherent jet formation and flow-acoustic feedback.

In some embodiments, noise reduction may be achieved using a single discharge outlet having a non-circular, asymmetric, or irregular geometry configured to inhibit vortex-shedding coherence and reduce tonal whistle formation without requiring multiple outlets or downstream accessory modules.

In various embodiments, the noise-reduction system includes an expansion chamber dimensioned to provide controlled decompression of discharged pressurized air. The chamber geometry may be selected to disrupt coherent jet formation, modulate shear-layer instabilities, and modify acoustic impedance characteristics associated with tonal generation.

One or more turbulence-generating features may be positioned within or defined by the surfaces of the expansion chamber. These features may include baffles, deflectors, perforated inserts, ribs, micro-structured liners, or textured regions configured to convert organized flow structures into randomized turbulence that dissipates acoustic energy.

In some embodiments, multiple discharge openings may be formed downstream of the expansion chamber. The discharge openings may include non-circular, polygonal, slot-type, curved-profile, fractal-like, or otherwise irregular geometries that inhibit the formation of coherent exhaust jets and reduce acoustic coupling between ports. Irregular spacing patterns may further limit constructive interference and standing-wave formation.

In other embodiments, noise reduction may be achieved using a single discharge opening having a non-circular, asymmetric, or irregular geometry. Such embodiments may operate independently of multi-port configurations and may be implemented in retrofit modules or integrated valve housings.

Additional embodiments may incorporate resonator cavities, such as Helmholtz resonators, quarter-wave structures, or side-branch cavities tuned to attenuate narrow-band frequencies not fully suppressed by turbulence or geometric modifications.

The disclosed systems may be configured for retrofit installation onto existing QRVs or implemented as integrated OEM valve housings. Additive manufacturing may be used to fabricate complex internal geometries, micro-structured surfaces, and multi-stage flow pathways not easily produced using conventional machining.

The systems described herein provide substantial noise reduction while preserving required airflow capacity, backpressure characteristics, and brake-system performance.

### BRIEF DESCRIPTION OF THE DRAWINGS

FIG. 1 illustrates a perspective view of a quick release valve system including a noise-reduction module.

FIG. 2 illustrates a cutaway view of a noise-reduction module or integrated QRV housing showing an expansion chamber, turbulence-generating features, micro-structured surfaces, and discharge-port geometries.

The drawings are not necessarily to scale. Features depicted in the drawings may be modified, rearranged, combined, or omitted without departing from the scope of the disclosure.

### DETAILED DESCRIPTION

### System Overview

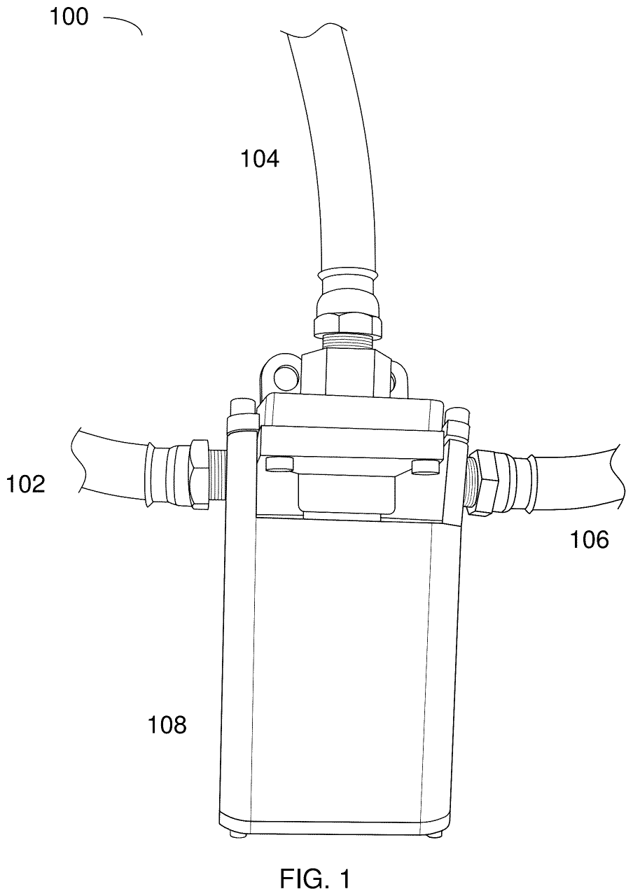

A noise-reduction module may be configured to attach to the exhaust outlet of an existing quick release valve (QRV). The module may include a housing defining one or more internal flow passages that route discharged pressurized air into an internal expansion chamber before release to the atmosphere. Referring to FIG. 1, a quick release valve system 100 may include a quick release valve 102 and a noise-reduction module 104 fluidly coupled to an exhaust port of the valve. The module 104 may define a housing 106 that encloses an internal expansion chamber and one or more turbulence-generating structures, and the system may further include an upstream supply line 108 and a downstream exhaust outlet 110 as schematically illustrated in FIG. 1.

The expansion chamber reduces air velocity, alters pressure gradients, and interrupts the coherent jet behavior associated with tonal whistle formation in conventional QRVs. The chamber may be sized according to system requirements and packaging constraints and may exhibit a wide range of volumes depending on desired acoustic and flow characteristics. By way of example only, the chamber volume may fall within, below, or above an illustrative range of approximately 0.25 to 10 times the effective upstream inlet volume. These values are not limiting, and any suitable chamber volume that provides controlled decompression, turbulence generation, or acoustic impedance modification may be used.

The module housing may include multiple discharge openings formed in its outer wall. These openings may have non-circular, asymmetric, or irregular geometries that inhibit vortex-shedding coherence, prevent symmetric shear-layer lock-in, and disrupt standing-wave modes typically associated with tonal emission.

The module may be mounted using bolts, clamps, brackets, sealing gaskets, keyed alignment features, magnetic couplings, or any combination thereof. Some embodiments may reuse existing QRV fasteners to simplify installation. Additional mounting techniques may include adhesive bonding, welded or brazed joints, or other equivalent fastening structures for securing the module housing relative to the quick release valve or surrounding hardware.

### Internal Architecture

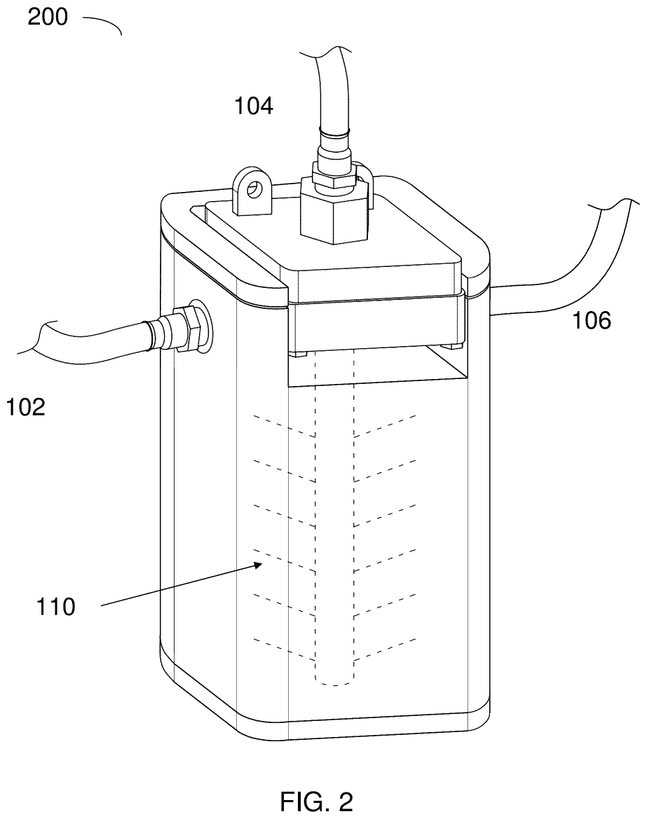

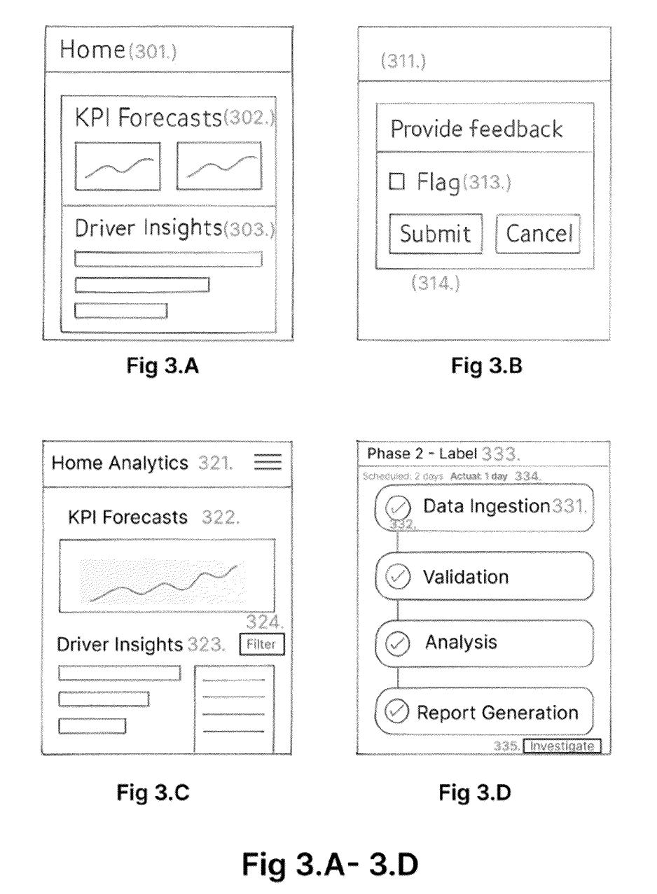

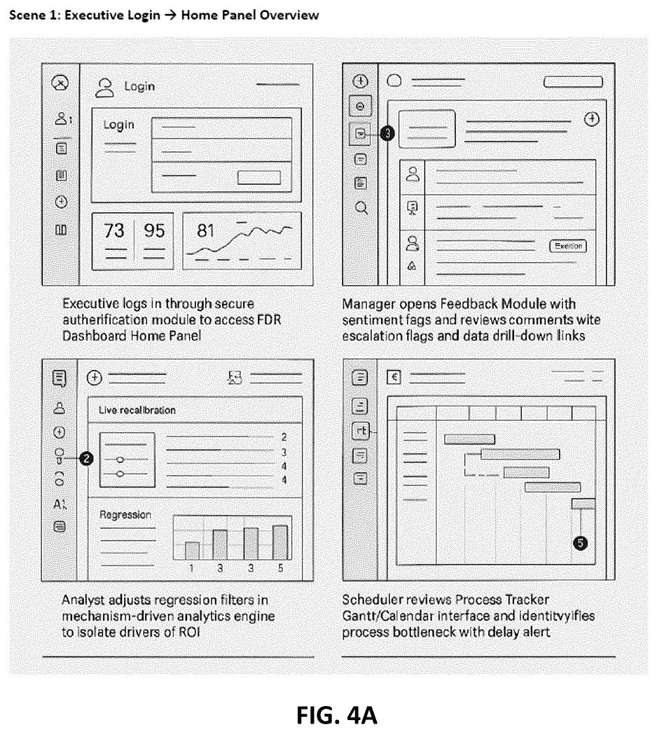

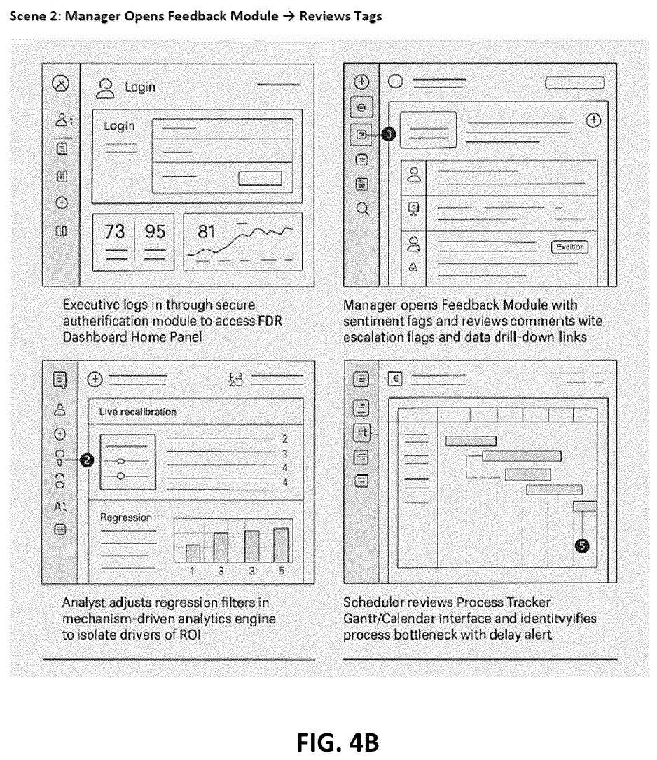

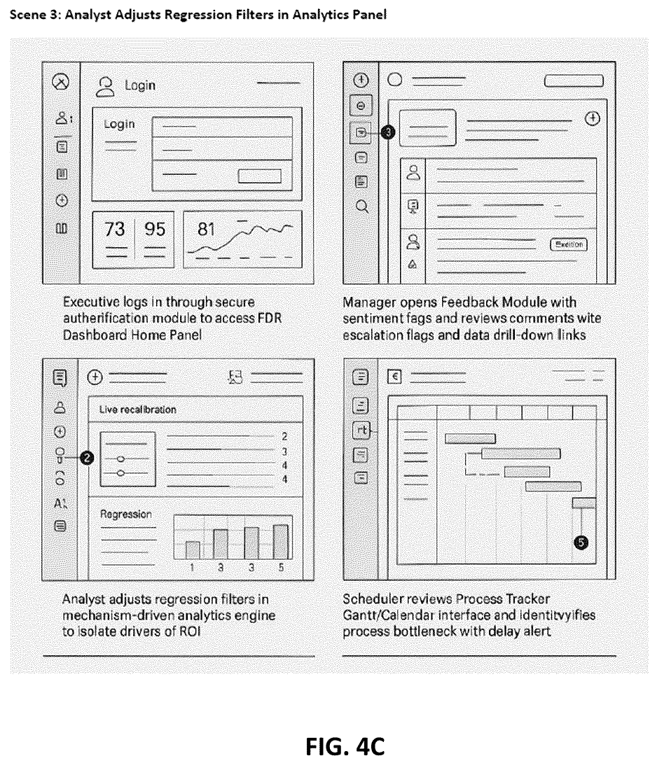

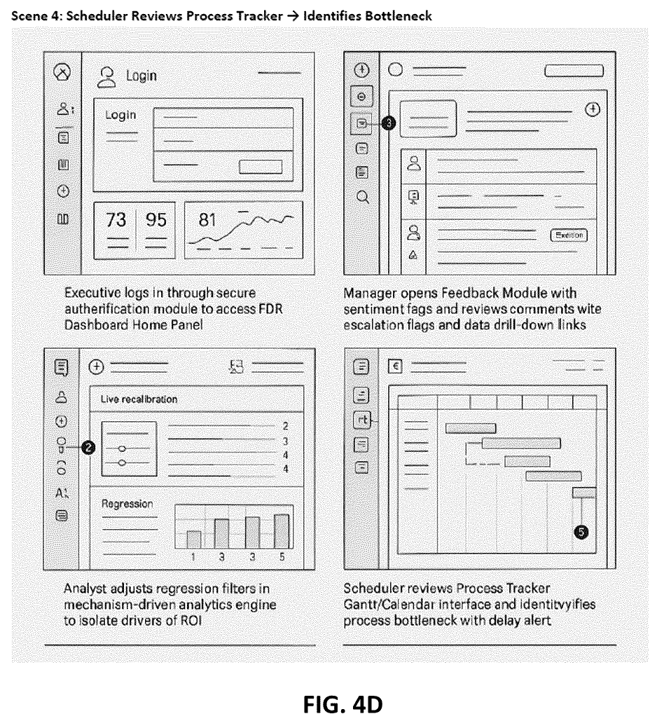

Referring to FIG. 2, internal architecture 200 may include a primary expansion chamber configured to receive high-pressure air from the QRV. Chamber geometry may be rounded, polygonal, stepped, or hybridized to create spatially varied pressure fields and reduce coherent flow structures.

Multiple chambers may be arranged in a series configuration to create progressive expansion stages. In such embodiments, connecting orifices may regulate the transition between chambers, shaping the pressure-drop curve and modifying acoustic impedance to target specific tonal frequencies.

In some embodiments, the internal chamber surfaces define irregular boundaries—e.g., angled faces, concave portions, contoured pockets, or recessed regions—that further disrupt symmetry and reduce coherent jet oscillation.

The internal chamber may also incorporate compliant or semi-compliant inserts that deform slightly under flow, introducing additional flow perturbations and localized viscous damping.

Additive manufacturing may be used to create continuous, monolithic internal geometries that include structures such as lattices, tapered ducts, or branching channels that would be impractical or impossible using conventional machining.

### Turbulence-generating Structures

Turbulence-generating structures may include baffles, flow-deflecting surfaces, perforated tubes, perforated plates, ribs, ridges, micro-features, or textured regions. These structures may be configured to disrupt coherent flow patterns, break up high-energy velocity gradients, and convert organized shear-layer modes into broadband turbulence.

Baffles may be oriented obliquely or orthogonally relative to incoming flow. Their shapes may include flat plates, curved plates, fractal-edge elements, perforated surfaces, or ribbed panels. These structures may produce controlled vortical fields that counteract larger-scale vortex shedding at the outlet.

Perforated structures may include uniform or gradient-density perforation patterns. Micro-perforated regions may function as distributed acoustic resistances, dissipating acoustic energy through viscous and thermal losses.

In some embodiments, the chamber includes micro-structured liners formed from elastomers, flexible polymers, composites, or multi-material structures. These liners may carry textures, dimples, channels, micro-grooves, or repeating cellular structures that alter boundary-layer behavior, enhance micro-scale turbulence, and introduce damping of acoustic waves.

Micro-structured liners may also serve as sacrificial components that absorb particulate impacts, road debris, and thermal cycling, thereby increasing system durability.

### Aeroacoustic Mechanisms and Disruption Strategies

Tonal noise in conventional QRVs is often produced by coherent vortex shedding at the circular outlet. As airflow passes through a single symmetric aperture, shear-layer instabilities couple with downstream flow structures to form oscillatory feedback loops that amplify discrete frequencies.

The disclosed systems mitigate these mechanisms by disrupting symmetry, modifying geometric boundary conditions, and altering flow-acoustic feedback pathways. Expansion chambers reduce velocity and broaden the spectral content of the exhaust. Turbulence-generating structures convert coherent structures into broadband turbulence. Non-circular outlets prevent shear-layer lock-in and eliminate the simple acoustic boundary conditions required for strong tonal formation.

These combined effects suppress whistling modes analogous to those observed in flutes, slot-type cavities, reed instruments, and orifice-based whistles.

### Resonator-Based Noise Attenuation

In some embodiments, tuned resonator cavities supplement turbulence-based attenuation. Such resonators may include Helmholtz resonators, quarter-wave resonators, and side-branch acoustic cavities.

Helmholtz resonators may be formed as enclosed cavities with neck openings coupled to the expansion chamber. When tuned to specific frequency ranges, these resonators may absorb narrow-band acoustic energy associated with dominant tonal harmonics.

Quarter-wave resonators may consist of tubular or slot-shaped cavities with depths selected to attenuate particular wavelengths. These structures may be implemented along chamber walls or integrated into the housing using additive manufacturing.

In some embodiments, the housing may include one or more controlled failure or pressure-relief features, such as a frangible wall section, burst panel, thin-walled region, or relief aperture, configured to open or vent air safely if exhaust flow becomes obstructed or if internal pressure rises above a predetermined threshold. Such features may be designed to prevent blockage of brake system exhaust and maintain safe brake operation in abnormal conditions.

Side-branch resonators may extend outward from the main flow path to absorb or reflect discrete frequency components.

Multiple resonators may be distributed across the housing to capture a broad range of frequencies and achieve broadband attenuation.

### Exit-Port Configuration

Discharge ports may include rectangular, oval, polygonal, curved-profile, segmented, or irregular shapes. Such geometries prevent formation of rotationally symmetric vortices, breaking the fundamental mechanism behind tonal whistle generation.

One or more ports may be sized so that each individual port maintains reduced velocity compared to a single large outlet. The total cross-sectional flow area may equal or exceed the flow area of the original QRV to maintain required exhaust flow capacity.

Irregular spacing of ports may prevent acoustic coupling between adjacent openings. Pseudo-random spacing or quasi-fractal distribution may further reduce constructive interference.

Port orientation may vary across the circumference or surface of the housing, directing flow vectors in different directions and diffusing acoustic energy.

In some embodiments, a quick release valve may incorporate a single discharge outlet having a non-circular, asymmetric, or irregular geometry configured to disrupt coherent vortex shedding and reduce tonal noise without the use of multiple outlets or additional downstream components. Exemplary outlet geometries may include oval, polygonal, slotted, curved, or irregular shapes selected to modify shear-layer behavior and inhibit formation of narrow-band acoustic emissions.

### Materials and Construction

Materials suitable for the disclosed systems may include metals, alloys, polymers, composites, high-temperature elastomers, or combinations thereof. Certain embodiments may include multi-material structures formed by additive manufacturing that integrate rigid and compliant regions.

The housing may be constructed from materials resistant to road debris, corrosion, oils, saltwater, and temperature cycling. Suitable metals include stainless steel, coated steel, titanium alloys, and aluminum alloys. Suitable polymers include high-temperature nylons, TPUs, PEEK, PPS, or elastomeric blends rated for −30° F. to 150° F. operation.

Additive manufacturing enables creation of integrated micro-features, perforated regions, internal resonator cavities, compliant liners, or multi-stage flow channels within a monolithic structure.

Compliant liners may be removable or replaceable for maintenance. Materials may include high-temperature TPUs, silicone elastomers, or composite elastomeric blends.

### Mounting and Integration

The module may be retrofittable onto existing QRV housings. Mounting interfaces may use existing bolt patterns or standard brake-system port geometries.

Attachment mechanisms may include bolts, clamps, brackets, keyed surfaces, snap-fit couplings, magnetic attachments, or sealing gaskets. Some embodiments may include modular adapters allowing compatibility with multiple QRV models.

Integrated versions may incorporate all noise-reduction features directly into the QRV body, eliminating the need for a separate module.

The system may preserve access to brake components for service, inspection, or replacement.

### Performance Monitoring and Diagnostics

Some embodiments may incorporate sensors or passive indicators to monitor system condition, detect blockages, or measure performance.

Suitable sensors may include pressure sensors, differential-pressure ports, temperature sensors, flow sensors, vibration sensors, or acoustic sensors.

Passive indicators may include pop-up flags, visual alignment tabs, or mechanical indicators triggered by abnormal flow or pressure conditions.

Sensor outputs may integrate with electronic brake-control systems or telematics systems for fleet monitoring.

### Alternative Embodiments

In some embodiments, multiple expansion stages may be used, each with its own turbulence-generation features and discharge regions.

Some systems may incorporate replaceable acoustic cartridges or media that can be swapped during maintenance.

The designs may be scaled for use with small commercial vehicles, medium-duty trucks, or heavy-duty transit buses.

Certain embodiments may use hybrid structures combining metal housings with elastomeric or polymeric liners to achieve specific acoustic or durability characteristics.

### Operation

During brake release, pressurized air enters the expansion chamber where pressure and velocity decrease. Turbulence-generation features disrupt coherent jet formation, while resonator cavities absorb targeted frequency components.

Downstream discharge through one or more non-circular ports diffuses flow energy and suppresses tonal emissions. The combined effects reduce overall sound pressure level and mitigate whistle-type noise.

The disclosed systems preserve brake response time and flow capacity while significantly reducing acoustic emissions.

What is claimed is:

1. A noise-reduction module configured to attach to an exhaust outlet of a quick release valve of a pneumatic brake system, the module comprising:
a housing configured to couple with the exhaust outlet and define at least one internal flow path;
an expansion chamber within the housing and dimensioned to receive pressurized air discharged from the quick release valve and provide controlled decompression;
one or more turbulence-generating features disposed in, on, or defined by surfaces of the expansion chamber and configured to disrupt coherent airflow and reduce acoustic energy; and
one or more discharge openings formed in the housing downstream of the expansion chamber, the discharge openings having a non-circular, asymmetric, or irregular geometry selected to inhibit formation of coherent exhaust jets and reduce tonal noise.

2. The module of claim 1, wherein the expansion chamber is dimensioned and shaped to generate controlled backpressure sufficient to inhibit formation of coherent airflow structures associated with tonal noise.

3. The module of claim 1, wherein the one or more discharge openings are sized, shaped, or distributed to maintain required aggregate flow capacity while reducing local exit velocity at each individual opening.

4. The module of claim 1, wherein the turbulence-generating features comprise one or more baffles, deflectors, perforated structures, ribs, or micro-structured liner elements.

5. The module of claim 1, wherein the non-circular, asymmetric, or irregular geometry of the discharge openings is selected to disrupt coherent vortex shedding associated with exhaust flow through the discharge openings.

6. The module of claim 1, wherein at least one of the discharge openings comprises a geometry selected from the group consisting of oval, rectangular, polygonal, slotted, curved-profile, and irregular shapes.

7. The module of claim 1, wherein the discharge openings are distributed in an irregular, quasi-random, staggered, or pseudo-random spacing pattern configured to prevent acoustic coupling between adjacent openings.

8. The module of claim 1, wherein the expansion chamber comprises two or more chambers arranged in series, parallel, branched, or hybrid configurations and connected through controlled orifices or transition passages.

9. The module of claim 1, further comprising a sealing system including a gasket, O-ring, elastomeric liner, or integrated sealing structure configured to provide an air-tight interface between the housing and the quick release valve exhaust outlet.

10. The module of claim 1, wherein the housing is secured to the quick release valve by reuse of existing bolts or fastening points of the valve assembly.

11. The module of claim 1, wherein the housing is attachable to the quick release valve using one or more attachment features selected from the group consisting of clips, brackets, clamps, bolt-on fasteners, magnetic couplings, keyed alignment features, sealing gaskets, interference or friction fits, bayonet or twist-lock couplings, quick-connect or snap-fit mechanisms, dovetail or rail-based guide structures, adhesive bonding, welded or brazed joints, and combinations thereof.

12. The module of claim 1, wherein the expansion chamber is dimensioned, shaped, or internally structured to create acoustic impedances that attenuate tonal, whistle-type, or broadband brake-exhaust noise.

13. The module of claim 1, further comprising at least one auxiliary resonator cavity acoustically coupled to the expansion chamber, the resonator cavity comprising a Helmholtz, quarter-wave, side-branch, or hybrid resonator dimensioned to attenuate specific frequency ranges.

14. The module of claim 1, wherein the expansion chamber further comprises fibrous packing, porous linings, micro-perforated structures, perforated elements, elastomeric liners, or multilayer composite acoustic absorbers.

15. The module of claim 1, wherein at least a portion of the housing, expansion chamber, or turbulence-generating features is formed by additive manufacturing to incorporate complex internal geometries.

16. The module of claim 1, wherein the housing is 3D-printed as a monolithic structure including integrated baffles, resonator cavities, perforated elements, or micro-featured surfaces.

17. The module of claim 1, wherein the housing or liner comprises materials resistant to oils, de-icing salts, road debris, moisture, temperature cycling, and vibration encountered in under-vehicle environments.

18. The module of claim 1, wherein the housing is configured to accommodate normal operating pneumatic pressures of the brake system and further comprises one or more pressure-relief or fail-safe features configured to vent air safely if exhaust flow becomes obstructed or if internal pressure exceeds a predetermined threshold, thereby preventing interference with brake system operation.

19. The module of claim 1, wherein the module is configured for hybrid implementation allowing use as (i) a retrofit attachment to an existing quick release valve or (ii) an integrated component of an original-equipment valve housing.

20. The module of claim 1, further comprising one or more sensors, passive indicators, or diagnostic structures configured to detect pressure, flow characteristics, blockage, turbulence, vibration, or acoustic performance.

21. The module of claim 20, wherein the one or more sensors are selected from the group consisting of pressure sensors, differential-pressure taps, flow sensors, acoustic sensors, vibration sensors, and temperature sensors.

22. An integrated quick release valve apparatus for a pneumatic brake system, the apparatus comprising:
a valve housing defining an internal expansion chamber configured to receive pressurized air from the brake system and provide controlled decompression;
a turbulence-generating system within the expansion chamber comprising one or more baffles, deflectors, perforated structures, or micro-structured liner surfaces arranged to generate turbulence and reduce air velocity;
one or more discharge ports formed in the valve housing downstream of the expansion chamber, the one or more discharge ports having a non-circular, asymmetric, or irregular geometry selected to disrupt coherent flow patterns and reduce tonal and broadband noise; and
a sealing interface configured to provide an air-tight connection between the valve housing and brake-system components.

23. The apparatus of claim 22, wherein the expansion chamber has a volume and geometry selected to provide rapid pressure reduction while maintaining sufficient flow capacity for brake operation.

24. The apparatus of claim 22, wherein the turbulence-generating system comprises fixed or modular elements positioned and shaped to increase acoustic attenuation while minimizing flow restriction.

25. The apparatus of claim 22, wherein the discharge ports are sized, shaped, or distributed to maintain required aggregate flow capacity while limiting exit velocity for each individual port.

26. The apparatus of claim 22, wherein the valve housing comprises materials or multi-material structures resistant to thermal, mechanical, vibrational, chemical, or environmental stresses encountered in heavy-duty vehicle operation.

27. The apparatus of claim 22, wherein at least a portion of the valve housing or its internal structures is formed by additive manufacturing to incorporate complex internal geometries.

28. A method of reducing noise generated during operation of a pneumatic brake system, the method comprising: directing pressurized air discharged from a quick release valve into an expansion chamber of a noise-reduction system coupled to, or integrated with, the quick release valve; disrupting coherent airflow using turbulence-generating features disposed in, on, or defined by surfaces of the expansion chamber; reducing air velocity through controlled decompression within the expansion chamber; generating controlled backpressure sufficient to inhibit formation of coherent airflow structures associated with tonal noise; and discharging the air through one or more discharge openings having non-circular, asymmetric, or irregular geometries configured to reduce tonal and broadband noise.

29. The method of claim 28, further comprising distributing the discharge openings across a surface of the housing according to an irregular, staggered, quasi-random, or pseudo-random spacing pattern configured to reduce acoustic coupling.

30. The method of claim 28, further comprising regulating airflow between multiple expansion chambers arranged in series, parallel, or branched configurations through controlled orifices or transition passages.

31. The method of claim 28, wherein creating turbulence comprises positioning baffles, deflectors, perforated structures, or micro-textured liner elements to disrupt coherent air streams and convert organized flow energy into randomized turbulent motion.

32. The method of claim 28, further comprising dimensioning or shaping the expansion chamber to provide acoustic impedances that attenuate tonal, whistle-type, or broadband brake-exhaust noise.

33. The apparatus of claim 22, further comprising at least one auxiliary resonator cavity acoustically coupled to the expansion chamber, the resonator cavity comprising a Helmholtz resonator, quarter-wave resonator, side-branch resonator, or hybrid resonator configured to attenuate tonal, narrow-band, or broadband acoustic energy generated during brake-exhaust operation.

34. The apparatus of claim 22, wherein at least a portion of the expansion chamber includes an acoustic absorption medium comprising a fibrous packing material, porous lining, perforated acoustic layer, or composite damping material configured to dissipate acoustic energy.

35. The apparatus of claim 22, further comprising a pressure-relief or fail-safe structure including a thin-walled region, frangible seam, burst panel, relief aperture, or deformable section configured to vent air safely if internal pressure exceeds a predetermined threshold, thereby preventing obstruction of brake-system exhaust flow.
